(19) United States
(12) Patent Application Publication
(10) Pub. No.: US 2022/0012236 A1
(43) Pub. Date: Jan. 13, 2022

(54) PERFORMING INTELLIGENT AFFINITY-BASED FIELD UPDATES

(71) Applicant: salesforce.com, inc., San Francisco, CA (US)

(72) Inventors: James HARRISON, San Francisco, CA (US); Yang SU, San Francisco, CA (US); Bryan KANE, San Francisco, CA (US); Youdong ZHANG, Millbrae, CA (US); ANH KHUC, San Francisco, CA (US); DAN WILLHITE, San Francisco, CA (US); Matt CHAN, Mill Valley, CA (US); Nate BOTWICK, San Francisco, CA (US); Michael MACHADO, Burlingame, CA (US)

(21) Appl. No.: 17/373,344

(22) Filed: Jul. 12, 2021

Related U.S. Application Data
(60) Provisional application No. 63/050,698, filed on Jul. 10, 2020.

(51) Int. Cl. G06F 16/242; G06F 16/23; G06F 16/25; G06N 20/10; G06N 20/20

(52) U.S. Cl. CPC G06F 16/2428; G06F 16/235; G06N 20/20; G06N 20/10; G06F 16/256

(57) ABSTRACT

Described herein is a method, system, and non-transitory computer readable medium for updating fields in records. Initially, fields are displayed according to how frequently the fields are updated. One of the fields is selected and then records of a record type including the selected field are displayed. One of the records is selected and a form is displayed that enables a user to update the value stored in the selected field of the selected record.

### CROSS-REFERENCE TO RELATED APPLICATIONS

This application claims priority under 35 U.S.C. § 119(e) to U.S. Provisional Patent Application Ser. No. 63/050,698, which filed on Jul. 10, 2020. U.S. Provisional Patent Application Ser. No. 63/050,698 is hereby incorporated by reference in its entirety.

### BACKGROUND

In order to conduct their business and carry out day-to-day operations, business customers need to keep track of a plurality of records. Oftentimes, as businesses and projects of the customer grow, the number of records kept also grows in turn.

In order to keep information up to date, and to make plans ahead of time, every customer needs to update their records. Furthermore, every customer or company typically has their own way of planning and preserving information, internally updating records, etc., such that it is acceptable to their management and stakeholders. However, due to the magnitude of records and the often-unique ways and formats in which information is stored, the updating of the records is not able to be streamlined, and often occurs in a very cumbersome manner.

For example, such a customer may be asked to choose a record they would like to update from in a list of records. Having to do so, out of hundreds or even thousands of records, when only one update is desired, often amounts to be grossly time-inefficient and hinders performance efficiency for the customer. Furthermore, to get to some records often requires other records to be first filled out (pre-requisite records) or other steps to be taken, wherein these pre-requisite records or steps may have the same values or actions taken every time, and form further roadblocks in time and performance efficiency. Thus, in monitoring and planning for projects, opportunities, or day-to-day operations, such customers would benefit from an easier way to update their records that bypasses the tediousness associated with choosing a record through a long list of records every time, or pre-filling out values every time.

### BRIEF DESCRIPTION OF THE DRAWINGS

The accompanying drawings, which are incorporated herein and form a part of the specification, illustrate the embodiments of the present disclosure, and together with the description, further serve to explain the principles of the embodiments and enable a person skilled in the pertinent art to make and use the embodiments, individually, or as a combination thereof.

FIG. 1 is a block diagram of an example embodiment where a user of a customer user can use a user module to update their corresponding records of a multi-tenant data repository via a central module.

FIG. 2 shows the modular interface structure with respect to the user of a customer, records present within the multi-tenant data repository, and the updating interface structure, according to some embodiments.

FIG. 3 shows an example screen of a graphical user interface (GUI) for selecting fields in accordance with one or more embodiments.

FIG. 4 shows an example screen of a GUI for selecting a record in accordance with one or more embodiments.

FIG. 5 shows an example form for updating the value in a selected field of a selected record in accordance with one or more embodiments.

FIG. 6 shows a flowchart for updating a field in a record in accordance with one or more embodiments.

FIG. 7 shows an example screen for selecting a list of records in accordance with one or more embodiments.

FIG. 8 shows an example form for updating the value in a selected field of a record in accordance with one or more embodiments.

FIG. 9A shows a neural network, according to an embodiment.

FIG. 9B shows a random forest classifier using a forest of classification trees, according to an embodiment.

FIG. 10A shows a graph illustrating weighted SVMs, according to an embodiment.

FIG. 10B shows a graph illustrating feature-weighted SVM accounts, according to an embodiment.

FIG. 11 is a block diagram of an example cloud computing environment, according to an embodiment.

FIG. 12 is a block diagram of example components of the underlying structure of any of the systems presented in the following embodiments.

The drawing in which an element first appears is typically indicated by the leftmost digit or digits in the corresponding reference number. In the drawings, like reference numbers may indicate identical or functionally similar elements.

### DETAILED DESCRIPTION

Provided herein are system, apparatus, device, method and/or computer program product embodiments, and/or combinations and sub-combinations thereof, for the prediction of a record that a user is likely to edit, and the consequent display of the record in an efficient manner such that the user can edit the value of the record without having to waste a significant amount of time or without having to perform a significant number of steps.

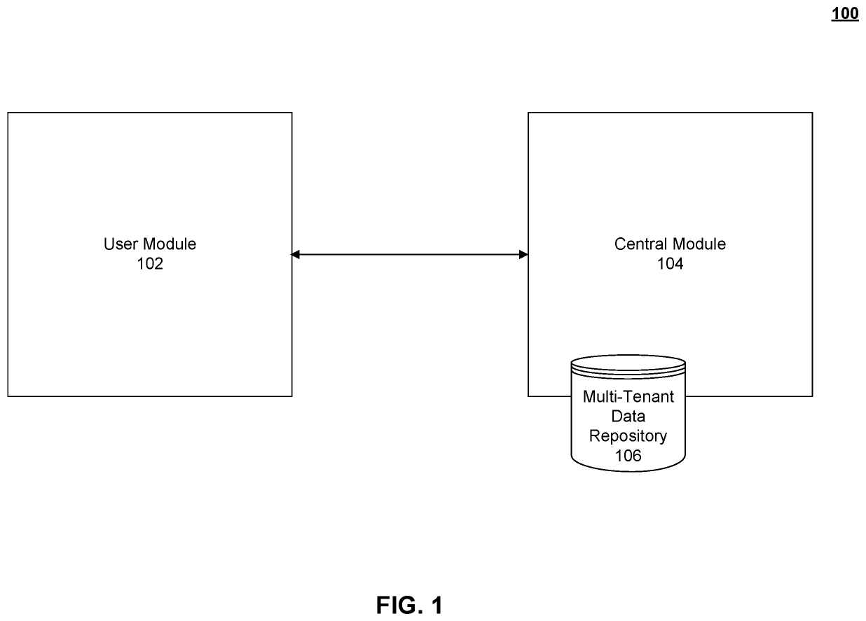

FIG. 1 is a block diagram of a data-transfer environment 100 showing the interaction between a user module 102, which may be accessed by a user of a customer (e.g., a business customer within a cloud-based record management system) seeking to update a record of the customer in a multi-tenant data repository, central module 104, and multi-tenant data repository 106. The multi-tenant data repository 106 is accessed by a plurality of tenants (customers), wherein each customer has their own data and records stored on the multi-tenant data repository 106.

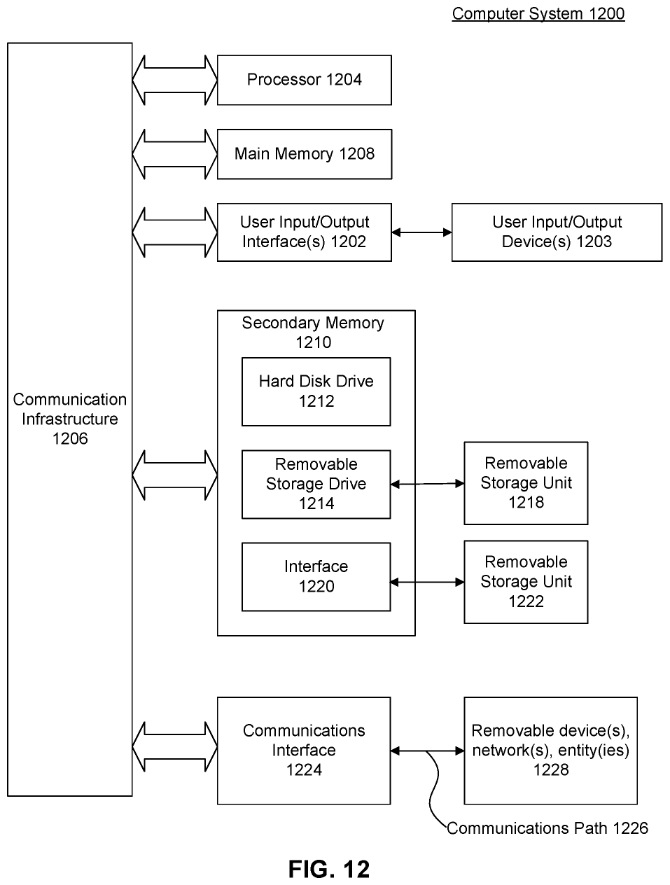

According to an embodiment, the central module 104 and the user module 102 may comprise one or more separate computer systems such as the computer system 1200 shown in FIG. 12, which can comprise a personal computer, mobile device, etc. To aid in describing the methods described herein, an example embodiment of the underlying structure will be described. The underlying structure of a computer system 1200, shown in FIG. 12, can implement a database and the sending and receiving of data. Although such a computer system, may, according to the embodiments describe above, include user module 102, central module 104, and multi-tenant data repository 106, in the embodiments described below user module 102 and central module 104 lie on different computer systems 1200. Computer system 1200 may include one or more processors (also called central processing units, or CPUs), such as a processor 1204. Processor 1204 may be connected to a communication infrastructure or bus 1206.

Computer system 1200 may be virtualized, or it may also include user input/output devices 1203, such as monitors, keyboards, pointing devices, etc., which may communicate with communication infrastructure 1206 through user input/output interface(s) 1202.

One or more processors 1204 may be a graphics processing unit (GPU). In an embodiment, a GPU may be a processor that is a specialized electronic circuit designed to process record data received from tables in the multi-tenant data repository 106 from associated values of fields of records, when data is to be processed in a mass quantity, for example for detecting pattern in previously filled out fields of records, or for taking into account associated factors of records when scoring which ones are likely to be accessed (which will be described infra) for making scoring assessments for a particular customer of a particular user, or for all users of a particular group for a particular customer. The GPU may have a parallel structure that is efficient for parallel processing of large blocks of data, such as mathematically intensive data common to computer graphics applications, images, videos, word-processing documents, PDF files, and the like, any of which can include table data received from multi-tenant data repository 106 as described above.

Computer system 1200 can also include a main or primary memory 1208, such as random access memory (RAM). Main memory 1208 can include one or more levels of cache (including secondary cache).

Computer system 1200 can also include one or more secondary storage devices or memory 1210. Secondary memory 1210 may include, for example, a hard disk drive 1212 and/or a removable storage device or drive 1214, which may interact with a Raid array 1216, which may combine multiple physical hard disk drive components (such as SSD or SATA-based disk drives) into one or more logical units, or a removable storage unit 1218. Removable storage unit 1218 may include a computer usable or readable storage device having stored thereon computer software (control logic) and/or data, including remotely accessed network drives. Removable storage unit 1218 may also be a program cartridge and cartridge interface, a removable memory chip (such as EPROM or PROM) and associated socket, a memory stick and USB port, a memory card and associate memory card slot, and/or any other removable storage unit and associated interface. Removable storage drive 1214 may read from and/or write to removable storage unit 1218.

Secondary memory 1210 may include other means, devices, components, instrumentalities or other approaches for allowing computer programs and/or other instructions and/or data to be accessed by computer system 1200. Such means, devices, components, instrumentalities or other approaches may include, for example, a removable storage unit 1222 and an interface 1220. Examples of the removable storage unit 1222 and the interface 1220 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1200 may further include a communication or network interface 1224. Communication interface 1224 may enable computer system 1200 to communicate and interact with any combination of external devices, external networks, external entities, etc. (individually and collectively referenced by reference number 1228). For example, communication interface 1224 may allow computer system 1200 to communicate with external or remote entities 1228 over communications path 1226, which may be wired and/or wireless (or a combination thereof), and which may include any combination of LANs, WANs, the Internet, etc. Control logic and/or data may be transmitted to and from computer system 1200 via communication path 1226.

Computer system 1200 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Any applicable data structures, file formats, and schemas in computer system 1200 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination, and may be used for sending or receiving data (e.g. between any of the source module 102, the central module 104, the multi-tenant data repository 106 in FIG. 1). Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1200, main memory 1208, secondary memory 1210, and removable storage units 1218 and 1222, as well as tangible articles of manufacture embodying any combination of the foregoing. Such control logic, when executed by one or more data processing devices (such as computer system 1200), may cause such data processing devices to operate as described herein.

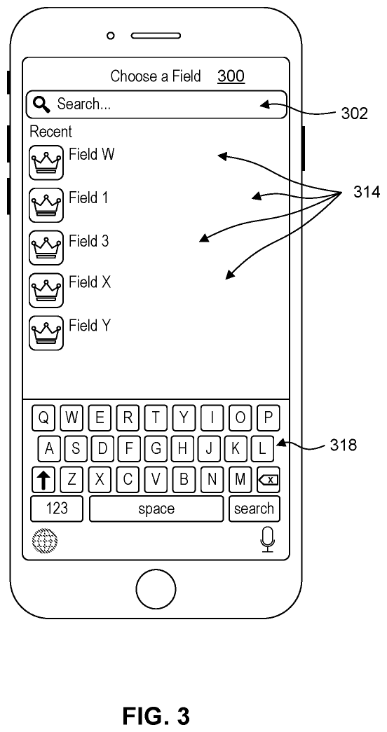

Computer system 1200 may be a client or server, accessing or hosting any applications and/or data through any delivery paradigm, including but not limited to remote or distributed cloud computing solutions such as cloud computing environment 502 which will be explained infra; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms. For example, the method of claim 6 (as will be explained infra) as well as GUIs in FIGS. 3-5 and 7-8 maybe delivered as part of a SaaS run from a distributed cloud computing environment run from the central module 104, including multi-tenant data repository 106.

In implementing the multi-tenant data repository 106, as an example approach, the computer system 1200 may use an in-memory database with persistence, which may store and access data objects from the primary memory 1208 of the computer system 1200 with a transaction log for persistence being stored in secondary memory 1210. Such a database can be used for storing and accessing the constituent data objects of these repositories, where records-accessed data based on monitoring user sessions is parsed into the multi-tenant data repository 106.

Alternatively, for storing and accessing the constituent data objects of these repositories, the computer system 1200 may implement only part of the data present as an in-memory database, using less primary memory 1208 than the first embodiment as described above, to reduce the in-memory footprint, and may instead store a larger portion of the data as a disk-based database within the secondary memory 1210 (more frequently accessed data is stored in primary memory 1208 while less frequently accessed data is stored in secondary memory 1210).

If the multi-tenant data repository 106 is implemented as a separate system 1200, it may send data to linked network entities through e.g. an internal network, the internet, etc. through the communication or network interface 1224, wherein the user module 102 and central module 104 may comprise entities 1228 present on an internal or external network, which may be accessed through communications path 1226. Alternatively, if the central module 104 is present along with multi-tenant data repository 106 jointly in a computer system 1200, the computer system 1200 may implement the database using the communication infrastructure 1206 for communication between the central module 104, and multi-tenant data repository 106, but may send data to the user module 102 through the communications interface 1224, through communications path 1226, where central module 104 is a network entity 628.

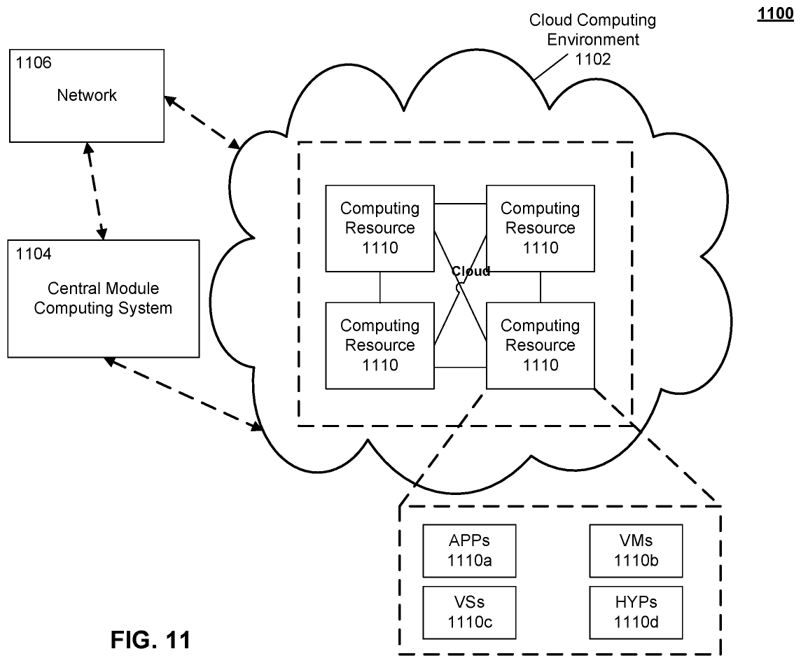

As shown in FIG. 11, cloud computing environment 1102 may contain backend platform 1108, in a block diagram of an example environment 1100 in which systems and/or methods described herein may be implemented. The central module 104 of FIG. 1, described above, may also include a host such as cloud computing environment 1102. The cloud computing environment 1102 may be accessed by the central module computing system 1104, of the same type of computing system 1200 as described above, wherein in an embodiment the central module computing system 1104 is included in the central module 104. In this case, the central module computing system 1104 of FIG. 12 may access the cloud computing environment 1102 by a communication or network interface 1224 as shown in FIG. 12, wherein a network gateway 1106 may comprise a remote entity 1228 accessed by the communications path 1226 of the central module computing system (where the three entities 1102, 1104, and 1106 shown in FIG. 11 would correspond to the central module 104 of FIG. 1). Alternately, the computing cloud environment 1102 itself may correspond to a remote entity 1228 in FIG. 12, and may be accessed directly by the central module computing system 1104 through a communications path 1226, for example through an application protocol interface (API), eliminating the need for a network gateway 1106 (both options are shown in FIG. 11, wherein the flow path above the central module computing system 1104 uses a network gateway 1106, and the flow path below the central module computing system 1104 connects directly to the cloud computing environment 1102, both shown using dashed bi-directional lines).

The devices of the environments 1100 and 100 may be connected through wired connections, wireless connections, or a combination of wired and wireless connections.

In an example embodiment, one or more portions of the data transfer environment 100 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

As explained above, the central module 104 of FIG. 1 may have a central module computing system 1104 as shown in FIG. 11 comprising a computer system of the same type as the computer system 1200 as shown in FIG. 12. The user module 102 or the multi-tenant data repository 106 may access the central module 104 through the central module computing system 1104, wherein the user module 102 or the multi-tenant data repository 106 may be external network entities 1228 from the perspective of the central module computing system 1104 in an embodiment, and may send data back and forth in the form of data packets through the communications path 1226 of the communications interface 1224 of computing system 11104, using e.g., TCP/UDP/FTP/HTML5 protocol. Alternately, the source module 102 may access the central module 104 through a front-end application 1110a (e.g. a web browser application, a web browser extension, proprietary OS application, standalone executable application, command line access shell program, FTP/UDP/TCP/HTML5 protocol, etc.) hosted as an application 1110a on a computing resource 1110 (explained infra) within the cloud computing environment 1102 hosted by the central module 104, in an embodiment.

The backend platform 1108 in FIG. 11 may include a server or a group of servers.

In an embodiment, the backend platform 1104 may host a cloud computing environment 1102. It may be appreciated that the backend platform 1102 may not be cloud-based, or may be partially cloud-based.

The cloud computing environment 1102 includes an environment that delivers computing as a service (“CaaS” as described above), whereby shared resources, services, etc. may be provided to the central module computing system 1104 and/or the backend platform 1108. The cloud computing environment 1102 may provide computation, software, data access, storage, and/or other services that do not require end-user knowledge of a physical location and configuration of a system and/or a device that delivers the services. For example, the central module computing system 1104, as well as source module 102 may receive data stored within or hosted on a database within computing resources 1110 within the backend platform 1108, through an application protocol interface (API) or any of the various communication protocols previously listed. The cloud computing environment 1102 may include computing resources 1110.

Each computing resource 1110 includes one or more personal computers, workstations, computers, server devices, or other types of computation and/or communication devices of the type such as computer system 1200 described above. The computing resource(s) 1110 may host the backend platform 1108. The cloud computing resources may include compute instances executing in the cloud computing resources 1110. The cloud computing resources 1110 may communicate with other cloud computing resources 1110 via wired connections, wireless connections, or a combination of wired or wireless connections as described above.

Computing resources 1110 may include a group of cloud resources, such as one or more applications (“APPs”) 1110a, one or more virtual machines (“VMs”) 1110b, virtualized storage (“VS”) 1110c, and one or more hypervisors (“HYPs”) 1110d.

An application 1110a may include one or more software applications that may be provided to or accessed by a computer system 1200. In an embodiment, the central module 104 may only include a cloud computing environment 1102 executing locally on a computer system 1200 of the central module computing system 1104. The application 1110a may include software associated with backend platform 1108 and/or any other software configured to be provided across the cloud computing environment 1102 (e.g. to source module 102). The application 1110a may send/receive information from one or more other applications 1110a, via one or more of the virtual machines 1110b. Computing resources 1110 may be able to access each other's applications 1110a through virtual machines 1110b, in this manner. In an alternate embodiment, a separate central module computing system 1104 is not needed, and the central module 104 only comprises the cloud computing environment 1102, hosted and executed by computing resources 1110, and communicating with the source module 102 using the communications interface 1224 of one of the computing resources 1110, or via app 1110a, using any of the various communication protocols mentioned above.

Virtual machine 1110b may include a software implementation of a machine (e.g., a computer) that executes programs like a physical machine. This may be of particular use in the alternate embodiment where there is no separate central module computing system 1104 of the type of computer system 1200. In this embodiment, the central module computing system 1104 may be a virtualized machine 1110b, and may communicate with source module 102 using the various communication protocols listed above, via an application 1110a. Virtual machine 1110b may be either a system virtual machine or a process virtual machine. A system virtual machine may provide a complete system platform that supports execution of a complete operating system (OS). A process virtual machine may execute a single program and may support a single process. The virtual machine 1110b may execute on behalf of a user (e.g., the administrator of the central module 104) and/or on behalf of one or more other backend platforms 1108, and may manage infrastructure of cloud computing environment 1102, such as data management, synchronization, and accessing records and their values from the multi-tenant data repository 106.

Virtualized storage 1110c may include one or more storage systems and/or one or more devices that use virtualization techniques within the storage systems or devices of computing resource 1110. With respect to a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the central module 104 flexibility in how they manage storage for evaluation data from records of data accessed from the multi-tenant data repository 106 (as will be explained infra), as well as notifications designated for different end users at the user module 102. File virtualization may eliminate dependencies between data accessed at a file level and location where files are physically stored. This manner of block and file virtualization may enable optimization of storage use, server consolidation, and/or performance of non-disruptive file migrations.

Hypervisor 1110d may provide hardware virtualization techniques that allow multiple operations systems (e.g., “guest operating systems”) to execute concurrently on a host computer, such as computing resource 1110, which may include a computing system of the type of computing system 1200, and can in this manner host a virtualized hardware of a central module computing system 1104. Hypervisor 1110d may present a virtual operating platform to the guest operating systems, and may manage multiple instances of a variety of operating systems as these “guest operating systems,” which may share virtualized hardware resource, such as RAM, which may for instance access the data in the form of a database of records in multi-tenant data repository 106. Alternately, secondary memory may be accessed using virtualized storage 1110c, or on physical storage, such as the hard disk drive 1112, of a computing resource 1110 of the type of computing system as computing system 1200. In embodiments heretofore described, using a combination of RAM and secondary memory to access the database, such that a portion of the database may be in-memory and a portion of the database stored in files, is also envisioned.

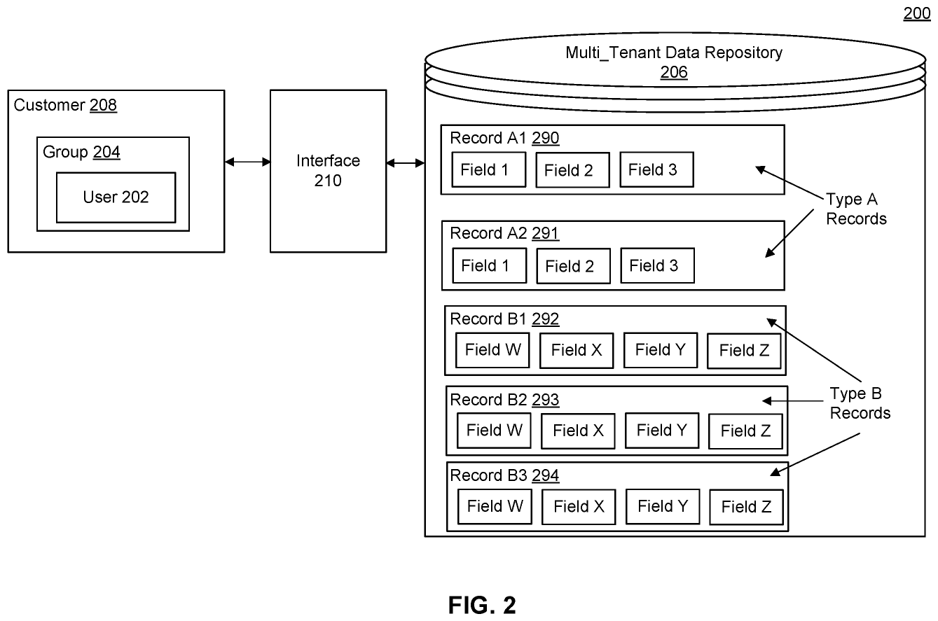

Further, user module 102 may also include an environment 1100 with a cloud computing environment 1102, instead of only a computing system of the type of computing system 1200. This environment is explained with reference to FIG. 2, wherein the user module 202 may be part of a larger group 204 that comprises a plurality of user modules 202. Analogously, a customer 208 may comprise several groups 204. This reflects the real-life situation where a customer that is a tenant of the multi-tenant database 106 may be a company.

In one or more embodiments, multi-tenant data repository 206 stores multiple records of different record types. A record type may also be referred to as a record schema. As shown in FIG. 2, multi-tenant data repository 206 is storing record A1 290, record A2 291, record B1 292, record B2 293, and record B3 294. Record A1 290 and record A2 291 are both records of record type A and thus have the same fields (e.g., field 1, field 2, field 3). In contrast, record B1 292, record B2 293, and record B3 294 are all records of record type B and thus have the same fields (e.g., field W, field X, field Y, field Z). A record type may have any number of fields. Although two records may belong to the same record type and thus have the same fields, the two records may store different values for a specific field. For example, field 1 may be a city field. Record A1 290 may store “Miami” in field 1, while record A2 291 may store “Chicago” in field 1. Those skilled in the art, having the benefit of this disclosure, will appreciate that some fields are frequently updated (e.g., daily, weekly, etc.), while other fields are rarely or never updated.

In one or more embodiments, customer 208 (e.g., a company) may have several project teams or groups 204, that may include professionals such as sales staff, engineers, troubleshooters, accountants, etc. With varied roles, these professionals, or users 202, would access the multi-tenant database repository 206 through an interface 210. Interface 210 may be accessed by users to view records, create records, delete records, and update records (e.g., modify/edit one or more fields of the records) in the multi-tenant database repository 206. Interface 210 may be implemented as a graphical user interface (GUIs) with one or more screens and/or forms. Each screen may have GUI components (e.g., textboxes, drop-down boxes, radio buttons, buttons, etc.) that can be manipulated by the user. The interface 210 may be accessed from any type of user computing device including a desktop personal computer (PC), a laptop, a smartphone, a tablet PC, etc.

FIG. 3 shows an example screen 300 of the interface 210 in accordance with one or more embodiments. The screen 300 may be displayed on the user module 202 (e.g., a smart phone). The screen 300 may correspond to a homepage of the user. The screen 300 displays a list of fields 314 (e.g., a list of field identities/names) belonging to record types in the multi-tenant data repository 206. In one or more embodiments, the first N entries (e.g., N=5) in the list correspond to the N most frequently updated (e.g., modified, edited) fields over a time period by the user, by other users belonging to the same team or company as the user, by other users sharing the same demographic profile as the user, etc. The remaining entries on the list may include the remaining fields (e.g., fields that are not in the top N fields) sorted in alphabetical order or based on how recently the field was updated. Additionally or alternatively, the entire list of fields may be sorted by how frequently the fields are accessed and the top N fields are marked as “suggested”. In one or more embodiments, only the top N fields are displayed (e.g., list 314 only has the top N frequently updated fields). In one or more embodiments, each field is associated with a score, and the fields in the list 315 are displayed according to an ordering of the scores (e.g., highest to lowest). Those skilled in the art, having the benefit of this detailed description, will appreciate that a record type may have any number of fields (e.g., 100+ fields) and that there may be multiple records types. Accordingly, if the list 314 includes every field, it may be computationally expensive to generate the list. Moreover, if the list 314 is being displayed on a smart phone or a computing device with a smaller screen size, it can be difficult for the user to navigate the large list 314 of fields. By restricting the list 314 to the top N frequently updated fields, computational resources are saved and navigational burdens on the user are mitigated.

Although not shown, each entry in the list might also identify the record type that includes the field. For example, if the first entry in the list 314 identifies field W, the first entry in the list might also identify record type B since, as shown in FIG. 2, field W is a field in record type B. A drop-down box or another type of GUI component may be used instead of the list 314 to display frequently updated fields and enable the selection of a field. Radio buttons or regular buttons may also be utilized to enable the selection of a field. To aid the user in finding a field, a search box 302 may be displayed wherein the user 202 may be able to type the name of a field, and find the field, for updating the value of the field in a specific record. Data input by the user as keystrokes in box 302, or by a mouse-click on fields 314, may be recorded by the central module 104 so as to provide training data as to which field 314 the user chose, which will be used as described infra. At the same time, associated factors with the accessing of the field that are related to the user and the company (e.g., time of day, weather, whether the user 202 was on business for the customer 208 and traveling, the day of the week, the presence of an ongoing business deal of the customer 208, etc.) may also be recorded by the central module for each field 314 that the user accesses by clicking on, or searching in box 302, in the screen 300 of FIG. 3.

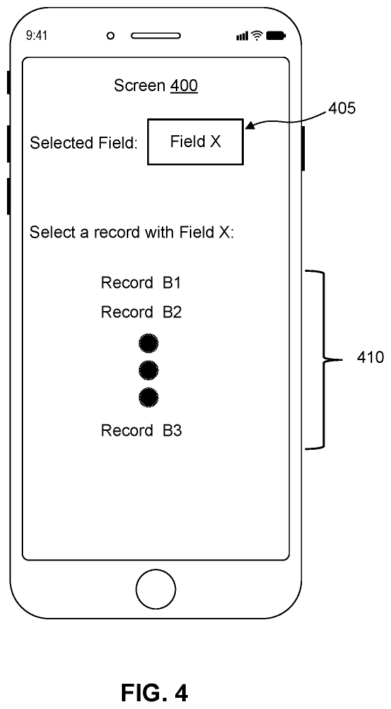

FIG. 4 shows another example screen 400 in accordance with one or more embodiments. Screen 400 and screen 300 may belong to the same GUI. The screen 400 may be displayed after the user has selected a field from the list 314 in screen 300. As shown in FIG. 4, the screen 400 displays the field 405 selected by the user (from the list 314) and a list of records 410 of the record type that includes the selected field. For example, if the user selects field X from the list 314, then list 410 may include record B1, record B2, and record B3. Although the records in the list 410 all have the selected field (e.g., field X), each record may have a different value for the selected field (e.g., field X). For example, if field X is a state, field X in record B1 may store “California,” field X in record B2 may store “Texas,” and field X in record B3 may store “Florida.” The list 410 of records may sorted in any order. For example, the list 410 may be sorted by how recently the records were accessed or modified. Screen 400 may have additional GUI components (not shown) that enable the user to search the list 410 of records for a specific record with the selected field and/or select one of the records in the list. Although screen 400 and screen 300 are shown as two separate screens, in one or more embodiments, screen 300 and screen 400 may be merged into a single screen. In such embodiments, list 410 may only appear after a field has been selected from list 314. The user may select one of the records from the list 410. The selection may be executed by clicking on one of the entries in the list 410. Additionally or alternatively, the selection may be executed by manipulating other GUI components such as buttons and radio buttons. Although FIG. 4 shows list 410, in other embodiments the records may be displayed and selected using a drop-down box or another GUI component.

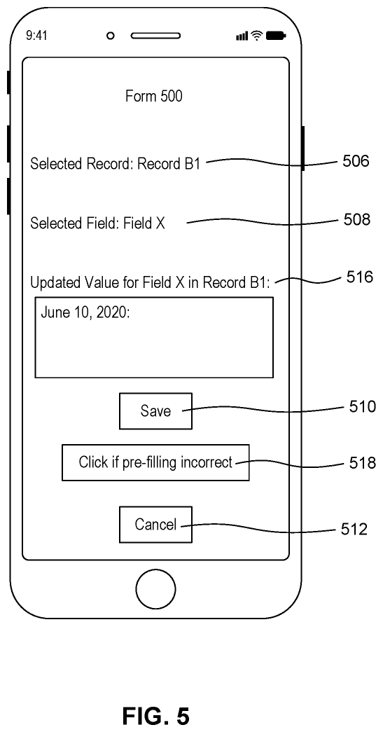

FIG. 5 shows an example form 500 in accordance with one or more embodiments. Form 500 may be part of the same GUI as screen 300 and screen 400. The form 500 may be displayed in response to the user selecting a record from list 410 (discussed above in reference to FIG. 4). The form 500 may display the selected record 506 and the selected field 508 (from list 314). The form 500 may also include a GUI component 516 (e.g., textbox) for collecting an updated value from the user for the selected field 508 in the selected record 506. When the form 500 is initially displayed, the GUI component 516 may be populated with the current value in the selected field of the selected record. The user may input an updated value by manipulating the GUI component 516. Once the user selects the “Save” button 510, the updated value provided by the user will be saved in the selected field of the selected record. If the user selects the “Cancel” button 512, the selected record will not be updated. In one or more embodiments, the GUI component 516 may be pre-filled by the system with an expected updated value (discussed below). If the expected updated value is correct, the user may select the “Save” button 510. Otherwise, the user may select button 518 to indicate the expected updated value is incorrect.

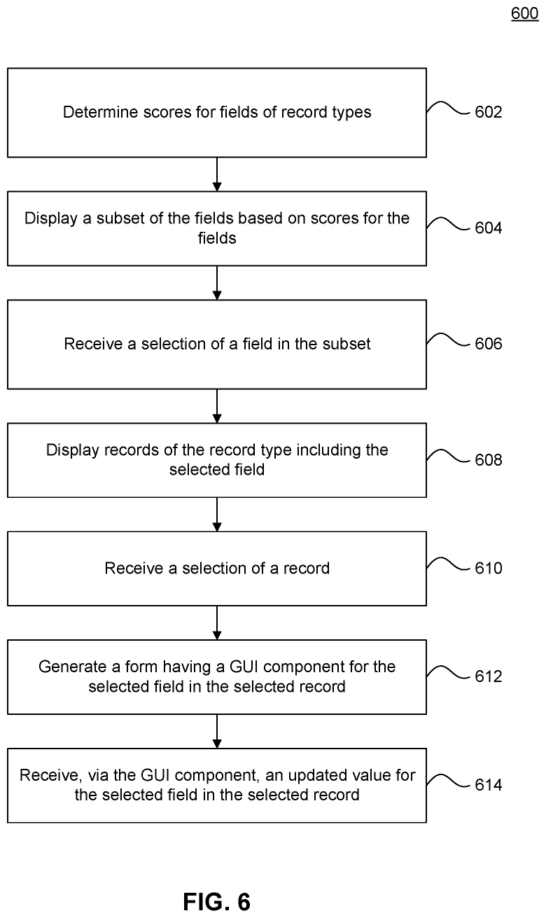

FIG. 6 shows a flowchart for updating a record in accordance with one or more embodiments. The steps in FIG. 6 may be executed by one or more of the components discussed above in reference to FIG. 1 and FIG. 2. In one or more embodiments, one or more of the steps shown in FIG. 6 may be omitted, repeated, and/or performed in a different order than the order shown in FIG. 6. Accordingly, the scope of the invention should not be considered limited to the specific arrangement of steps shown in FIG. 6. The steps shown in FIG. 6 may be implemented as computer-readable instructions stored on computer-readable media, where, when the instructions are executed, cause a processor to perform the process of FIG. 6.

At 602, scores for multiple fields are determined. As discussed above, a repository may store records of various record types. Each record type may include any number of fields. Some fields may be updated (e.g., modified, edited) very frequently. Other fields may be rarely or never updated. In one or more embodiments, the score for a field reflects how frequently the field is updated by a user, by other users on the same project team as the user, by other users belonging to the same company as the user, and/or by other users of the same demographic profile as the user. The scores may be determined using machine learning. Additionally or alternatively, the scores may be obtained from any source including external sources. In one or more embodiments, each time a field of a record type is updated (regardless of the specific record), the score for the field is incremented by a constant k (e.g., k=1). Then, the score decays over time. Accordingly, higher scores indicate the field is updated more frequently.

At 604, a subset of fields are displayed (e.g., the identities/names of the fields are displayed). An example of displayed fields is shown in FIG. 3 (discussed above). In one or more embodiments, only the fields with the top N scores are displayed. Those skilled in the art, having the benefit of this detailed description, will appreciate that a record type may have any number of fields (e.g., 100+ fields) and that there may be multiple records types. Accordingly, it may be computationally expensive to display every field. Moreover, if all fields are being displayed on a computing device with a smaller screen size (e.g., smart phone), it can be difficult for the user to navigate the large numbers of fields. By only displaying the fields with the top N scores, computational resources are saved and navigational burdens on the user are mitigated. Moreover, these displayed fields most likely include the field(s) the user wishes to update.

At 606, a selection of a field is received from the user. The user may select the field by clicking on it. Additionally or alternatively, each field may be displayed with a radio button and the user selects the field by selecting the radio button. Additionally or alternatively, the fields may be displayed within and selected via a drop-down box.

At 608, records of the record type including the selected field are displayed. The records may be displayed on the same screen as the fields (at step 604) or on a different screen. An example of displayed records is shown in FIG. 4 (discussed above). The displayed records may be sorted based on how recently the records were accessed. For example, the most recently accessed records may be at the bottom of the list.

At 610, a selection of a record is received from the user. The user may select the record by clicking on it. Additionally or alternatively, each record may be displayed with a radio button and the user selects the record by selecting the corresponding radio button. Additionally or alternatively, the records may be displayed within and selected via a drop-down box.

At step 612, a form is generated. An example of the form is shown in FIG. 5 (discussed above). The form includes a GUI component (e.g., textbox) corresponding to the selected field (from step 606) in the selected record (from step 610). The GUI component may be populated with the current value of the selected field in the selected record.

At 614, an updated value for the selected field in the selected record is received from the user via the GUI component. Specifically, the user may manipulate the GUI component to input the updated value. This updated value may be stored in the selected field of the selected record.

In one or more embodiments, it may be determined that two or more fields are frequently updated together. For example, it may be determined that when field X is updated by a user, 95% of the time field Y is then also updated by the user. In such embodiments, the generated form may have multiple GUI components (e.g., textboxes), with one GUI component corresponding to the selected field in the selected record (e.g., field X), and the one or more remaining GUI components corresponding to other fields (e.g., field Y) in the selected record that are likely to be updated along with the selected field. These updated values for the multiple fields may be stored in the selected record.

Although step 606 only mentions selecting a single field, it may be possible for the user to select multiple fields belonging to the same record type. In such embodiments, the form in step 612 may include multiple GUI components (e.g., textboxes), with each GUI component corresponding to one of the selected fields. These updated values for the multiple selected fields may be stored in the selected record.

Although step 610 only mentions selecting a single record, it may be possible for the user to select multiple records. The selection process may include the user clicking multiple records of interest from the displayed records. Additionally or alternatively, the records may grouped/organized into lists, and selecting the multiple records may include the user selecting one of the lists.

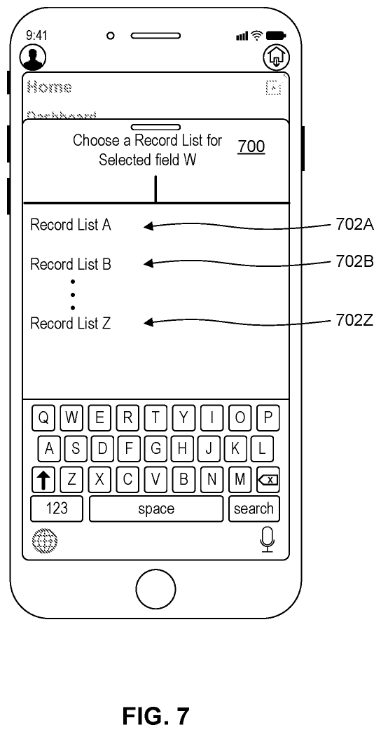

FIG. 7 shows an example screen 700 in accordance with one or more embodiments. FIG. 7 may be displayed after the user has selected field W (at 606 in FIG. 6). As shown in FIG. 7, multiple record lists are displayed (e.g., record list A 702A, record list B 702B, record list Z 702Z). Each record list 702 includes one or more records of the record type that includes selected field W. Assume in this example that the user selects record list A 702A and that record list A has 5 records.

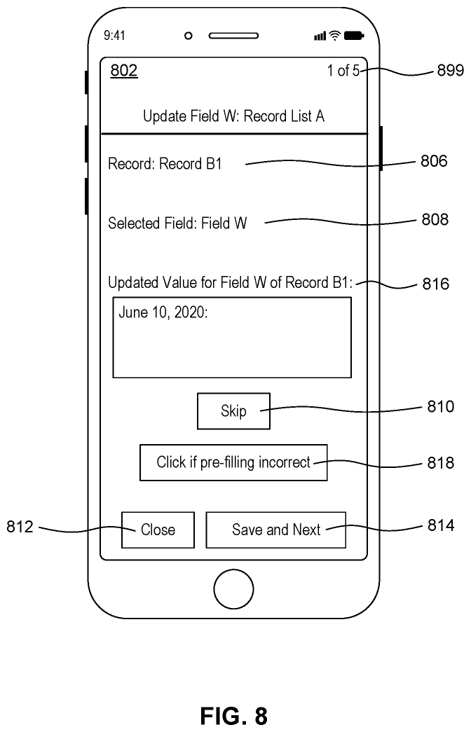

FIG. 8 shows an example form 802 that may be generated in response to the user selecting record list A 702A. As shown, the form 802 identifies one of the records 806 from the selected record list (e.g., record list A), and identifies the selected field 808 (e.g., field W). The form 802 also includes a GUI component 816 (e.g., textbox) corresponding to the selected field in the identified record of the record list. When the form 802 is initially displayed, the GUI component 816 may be populated with the current value in the selected field of the identified record. In one or more embodiments, the GUI component 816 may be pre-filled by the system with an expected updated value (discussed below). If the expected updated value is incorrect, the user may select the button 818. The user may input an updated value by manipulating the GUI component 816. In response to selecting the “Save and Next” button 814, the updated value provided by the user may be saved in the selected field of the identified record, and a new form is generated and displayed. This new form is essentially the same as form 802, except the new form identifies the next record in the list of records, and the GUI component (e.g., textbox) in the new form corresponds to the selected field in said next record. Each time the “Save and Next” button is selected, a new form is generated in order to update the selected field of the next record until the last record in the selected list of records is reached. This may be referred to as a bulk-update. A counter 899 may be displayed at the top of the form to indicate progress in updating the records in the list of records.

Like the “Save and Next” button 814, the “Skip” button 810 also generates a new form for the next record in the list of records. However, selection of the “Skip” button 810 does not save the updated value provided by the user (via GUI component 816) in the selected field of the current record. Selection of the “Close” button 812 ends the bulk-update.

The pre-filling of the GUI component 516 or GUI component 816 with an expected updated value, based on the stored previously inputted values of the first record by the user, will now be described in more detail. In element 516 or 816, a user may enter a keyword (KW). For example, the seller 122 may enter known parameters such as a current date, time, or day of the week to uniformly start off their entry every time they update the field 516 or 816, or they might also append their entry onto a previous set of dated entries.

The previously input entries may be analyzed through machine-learning pattern detection analysis to determine if a commonly detected parameter such as the date, time, day of the week is entered, or the appending onto previous entries is occurring.

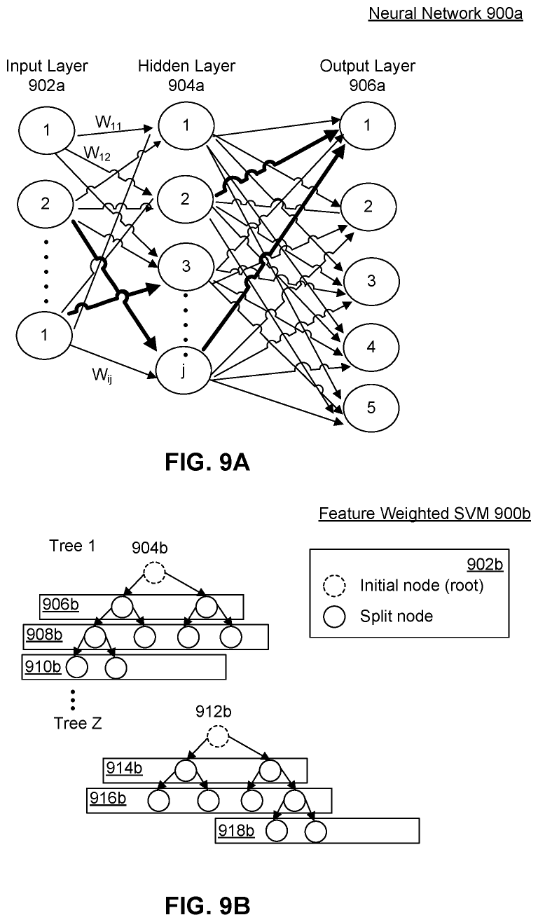

The module used to generate such determinations will herein be described. In an embodiment such a module may be a neural network with hidden layers and backpropagation as shown in FIG. 9A. The inputs in this case would be the keyword or keywords that the user is typing into the prompt for 516 or 816, wherein each saved entry of the user of 516 or 816 forms a separate set of inputs. The neural network may be used as a machine learning classifier for these inputs to designate a potential category or categories of detected parameters, such as date, time of day, day of the week, appending, or none of the above. By using such a classification technique, it may be possible to create a system of nodes with weights. This system of nodes with weights may be used to give a reliable prediction of the category of parameters the user's input belongs to. The different components of the neural network model shown in FIG. 9A will herein be explained, according to some embodiments. The input layer 902a contains nodes 1 to i, which represent inputs into the model. Each of these nodes corresponds to a different aspect of the string entered. In particular, the user's string, as inputted in 816, etc., is first tokenized into words, and the tokenized words are stemmed. Training data may be used (where the category is known), where full sentence descriptions of the product may be transformed. Such a transformation may tokenize each word in sentence descriptions of a known category, create word stems, etc. After enough training data is used, there may be a collective library of word stems, some of which are associated with only one category, some associated with multiple categories, etc., such that when an input string in 516 or 816 is parsed apart, where one input node may correspond to each word, these nodes can be compared to the library of word stems associated with each category.

For example, the stem ‘Jun’ or ‘06/’ may be in the library of word stems array associated with the category “Month.” Thus if the user enters “June 10, 2020” as part of the input string 816, node 1 of the input layer 902a may represent the word stem “Jun” (month), node 2 may represent “10” (day), and node 3 may represent “2020” (year). These nodes may then be compared to the word stems from the training library (called “bag of words”), wherein nodes 2 through 3 maybe assigned the value 0 if they do not match up with any word stems in the bag of words, and node 1 may be assigned the value 1 if it does match up with a word stem in the bag of words (in this example it matches ‘Jun’ from above). In practical terms, the input is parsed through and correlated with a series of 0's and 1's where 1's correspond to words that are in the bag of words.

Through repeated rounds of the neural network being trained with training data, each stem may have a different weight wᵢⱼ associated with the stem going to the next layer 904a, and eventually to the output layer 906a. This is because some words in the bag of words may have an association with particular categories and may be more important than others. For example, the word “twenty” may be deemed to be less important than word stems like “2020” which clearly signal a year of a date. Output layer 906a may include five nodes as an example, nodes 1, 2, 3, 4 and node 5, representing five categories (e.g. date, time, day of the week, appending onto previous entries, or a catchall for none of the above).

Based on the inputs and weights from each node to the other (wiᵢⱼ as shown in FIG. 9A), the results of the output layer are tabulated, and the node (1 through 5) in the output layer with the greatest result is outputted as the outcome of the predictive analysis. In this case, since ‘Jun’ may have a particular association with month, and “2020” has a clear association with year, the weights from the input layer nodes to the output layer node 1 may carry more weight than from the input layer nodes to the output layer nodes 2-5 (assuming the output layer node 1 represents date).

In traversing from the input layer 902a to the output layer 906a, there may also be several hidden layers 904a present. The number of hidden layers 904a may be preset at one or may be a plurality of layers. If the number of hidden layers 904a is one (such as shown in FIG. 9A), the number of neurons in the hidden layer may be calculated as the mean of the number of neurons in the input and output layers. This is derived from an empirically-based rule of thumb in ease of calculating weights across layers. According to an additional rule of thumb, in an embodiment to prevent over-fitting, where the number of neurons in input layer 902a is Nᵢ and the number of neurons in the output layer is Nₒ, and the number of samples in the training data set of all word stems associated with categories is Nₛ, then the number of neurons Nₕ in one hidden layer may be kept below

$${N}_{h} = \frac{{N}_{s}}{( α * ( {N}_{i} + {N}_{o} ) )} , \qquad ( equation 1 )$$

where α is a scaling factor (typically ranging from 2-10). In this manner, the number of free parameters in the model may be limited to a small portion of the degrees of freedom in the training data, in order to prevent overfitting.

From the input layer, based on the weights from each node in the input layer 902a to the hidden layer 904a shown in FIG. 9A, there may be a sigmoidal transfer function in going from the input layer 902a to the hidden layer 904a. Initially, the weights w_{i,j} may be initialized to random values between 0 and 1. An input node word-stem that corresponds to a word stem in the bag of words may then be propagated according to these weights (forward-propagation), wherein the hidden layer 904a forms the first outputs for the neurons of the input layer 902a. For example, input given as “purple” for neuron 1 in the input layer 902a in the example above would be multiplied respectively by 0 if it did not correspond to a word stem in the bag of words.

By contrast, neuron 1 (“June”) would be multiplied by weights w₁₁ and w₁₂, etc., until wi₁ⱼ, respectively, and in the same manner these hidden layer nodes would be summed to form the output to the hidden layer 904A (e.g. node 1 in the hidden layer in the example above would be the sum of W₁₁, +W₂₁+W₃₁+W₄₁). Then the node 1 at the hidden layer 904a may take this net value and transfer this activation value to see what the neuron output onwards to the output layer actually is. At each output layer (hidden layer 904a with respect to input layer 902a, and output layer 906a with respect to hidden layer 904a) transfer functions comprising the sigmoid activation function

$$S ( x ) = \frac{1}{1 + {e}^{- x}} , \qquad$$

hyperbolic tangent function

$$tan hx = \frac{{e}^{2 X} - 1}{{e}^{2 X} + 1} ,$$

or smooth rectified linear unit (SmoothReLU) function ƒ(x)=log(1+e^{x}) may be used to transfer outputs.

In the example above, the output given from the input layer 902a to neuron 1 of the hidden layer 904a would be inputted as the activation value to be transferred at the hidden layer 904a to one of the transfer functions described above, and the output would form the value of neuron 1 of the hidden layer 904a to be given onward as input to the output layer 906a, and multiplied by respective weights to the neurons 1 and 2 of the output layer. In this manner, full forward propagation of input nodes 1 through I in the input layer 902a may be achieved to the output layer 906a.

Then, to conduct backpropagation, error is calculated between the expected outputs and the outputs forward propagated from the network. In training the neural network, k-fold cross validation, may be used, particularly when the data sets are small. For k-fold cross-validation, for example, there could be an aggregated set of sentence descriptions all input by the user that are known to be associated with dates (Category 1) or time (Category 2), day of the week (category 3), or appending (category 4), or neither (category 5) with respect to different associated word stems for each group, comprising all the components described above. This set of sentence descriptions may be shuffled and split into a k number of groups (e.g., 5 groups if k is 5, each holding a particular number of results (Category 1/Category 2) and corresponding associated word stems). Then, for each unique group, the group can be held out as a test data set, with the remaining groups of aggregated sentence descriptions being used to train the classifier.

Finally, based on the training, the accuracy with respect to the test group can be evaluated. One group may be held for testing and the others may be used to train the model. In this manner, error is calculated between the expected outputs of 1,0 so described, and the outputs actually forward propagated by the network (initially by random weights assigned as described above).

To transfer the error, the error signal to propagate backwards through the network is given by error=(expected−output)*transfer_derivative(output), wherein transfer_derivative is the derivative of the transfer function used (sigmoid, hyperbolic, or SmoothReLU).

The error signal for a neuron in the hidden layer 904a is then calculated as the weighted error of each neuron in the output layer, according to the weights from the output layer to the neuron in the hidden layer 904a. Similarly, the error signal from the hidden layer is then propagated back to the input layer 902a. Once the errors are calculated for each neuron in the network via the back propagation method described, the errors are used to update the weights according to the formula new_weight=old_weight+learning_rate*error*input. Here, the old weight variable is the previous given weight in the model, the learning_rate variable is a value from 0 to 1 that specifies how much to change the old weight to correct for the error, the error variable is the error calculated by the backpropagation procedure, and the input variable is the value of the input that caused the error.

Over time, this model can be developed to form a robust prediction analysis. As for a given input there are probably several potential output categories, the output layer 906a may consist of tens or even hundreds of nodes. Each output node in the end has a score from 0 to 1. The output node with the largest node is deemed to be the most likely category of product which the user's input (e.g. in field 516 or 816) may be associated with, and such an element can automatically be pre-filled into the form (e.g., the date, time of day, day of the week may be filled in, or previous entries if new information is constantly appended can be left intact). Accordingly, the second-highest score would denote the second most likely category of product associated with the user's input, and so on. Herein, if two nodes were above a certain threshold, it may mean that the tokenization of 816 indicates that both elements are present. In this manner, a threshold value at the output layer 906a may be used to decide which elements to pre-fill into the form 500 or 802 to be displayed.

Once these categories are displayed, the user may verify or nullify the result through feedback from the GUI, wherein the user can click 518 or 818 if the pre-filled text is incorrect. If the user does not click this button, then a value of ‘1’ is input into the output layer, and the other categories become ‘0’, and this result is backpropagated as described above to adjust the weights of the hidden and input layer to make the model more robust for future processing.

As discussed above in step 602 of FIG. 6, scores are determined for the fields. In one or more embodiments, machine-learning analysis as well as weighted machine-learning analysis may be used to determine scores and thus determined the fields that are most likely to be accessed by the user.

Firstly, machine-learning analysis using a support vector machine (SVM) may be conducted. In this embodiment, data from associating factors is considered along with the frequency of access when determining a score for the record. For example, if the user 202 always has a different record or field which he accesses depending on the day (Monday—finances, Tuesday—sales reports, etc. for updating the value of fields of these records), then merely determining the most frequently accessed record or field will not aid the user in overcoming the hurdle to search for these respective records. Other patterns that are present could be that the user only accesses a certain record after 9 PM (for example nightly sales to update figures), or when the weather is particularly rainy or the user is travelling he/she may access a particular record or field (for example reimbursements related to weather-related damages, etc., travel reimbursements, etc.). In order to account for these patterns and take cognizance of the impact they may have on scoring for overall “affinity” of a user to access them, a hyperplane may be created per the SVM protocol.

That is, all of these patterns may result in a binary outcome, wherein the user was or was not accessing records per these patterns (he/she was accessing a record or field because of the weather, or not because of the weather). As a result, based on a respective threshold (e.g. 35% or higher, or any other predetermined value as determined) value of a frequency of access of a record or field during the presence or absence of a particular noted associated feature (weather, time of day, weather, travel, etc.), a record or field may be designated as associated with a feature. Conversely, if the frequency of access of a record or field during the presence or absence of a particular noted associated feature is below the respective threshold, the record or field may be designated as not associated with an associated feature. Further, the threshold for each associated feature may be set and tweaked over time to reflect or not reflect association. In this manner, for each of the associated features there is a binary designation of being associated or not, wherein a hyperplane is then found by the SVM method to separate these points.

In order to determine which feature should be weighted more in finding such a hyperplane, a technique called feature weighted SVM is used, as shown in FIG. 9B. In this Figure, a random forest bagged classifier consisting of an ensemble of classification trees (CTs) is used. Each tree can be constructed using a different bootstrap dataset with randomly chosen record samples (out of the pool of all records), and each node may be split using the best among randomly selected associated features. These two kinds of randomness help to determine the most important feature against model over-fitting and noise. First, from the original data set, a random number of n features are selected out of all associated features at an initial node (e.g. 904b or 912b). Then, for the kth feature where k=1,2, . . . n , the best split sₖ is used. The data is then split at the node using the best split s among the n best splits. Then the previous three steps are repeated at every node. This results in a forest of trees from Tree 1 to Tree Z, as shown in FIG. 9B. To determine which feature had the most impact over splits of all trees in the forest, the Gini index technique may be used, to accumulate the Gini decrease at every split in the forest due to a given feature.

To calculate the Gini decrease the formula G=Σᵢ₌₁^{C}p(i)&(1−p(i)) wherein Ci is the number of classes and p(i) is the probability of randomly picking an element of class i. The best split is chosen by maximizing the Gini gain, which is calculated by subtracting the weighted impurities of the branches from the original impurity. The Gini decrease for all associated features is tabulated over all splits across the entire forest (of Trees 1 through Z). Then the tabulated Gini decreases are compared, and the feature with the greatest decrease (maximal Gini gain) is designated as the record or field the user would have the most affinity to access.

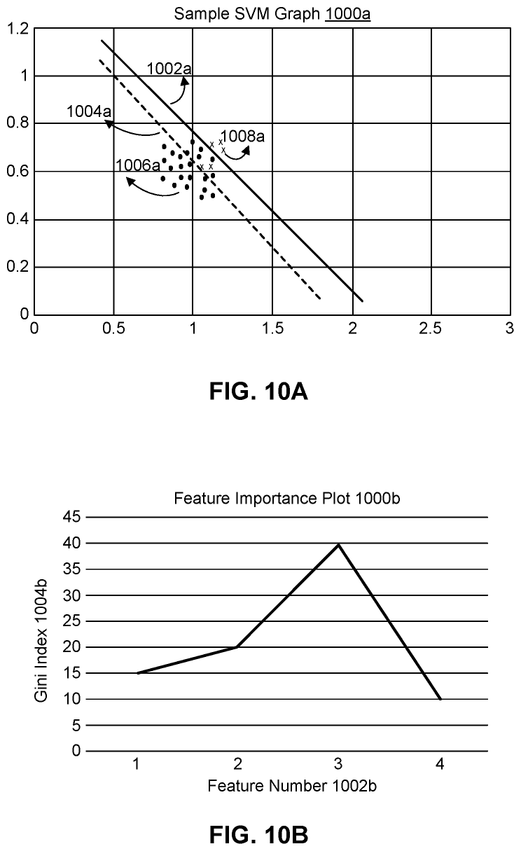

This field may be included in the top N fields displayed to the user (as shown in FIG. 3 and discussed above in reference to FIG. 3). The benefit of conducting the Gini analysis is that it helps to weight the features that are taken into account by the SVM. The effect can be seen in FIGS. 10A and 10B. As seen in FIG. 10A by weighting the features, the SVM also performs better with regard to outlier sensitivity. The cluster 1006a is more evenly split by feature weighting with the line 1004a, as opposed to the original line 1002a which is pulled to the right by the outliers to the right of the line.

Further, as shown in FIG. 10B, the Gini Index clearly indicates that feature 3 is orders of magnitude more important than the other features. If this were time of day versus traveling, versus day of the week versus weather, and one of them had a clear importance, it is important to assess the frequency of access by the user 202 relative to that specific associated feature, in order to determine what record or field the user would likely access in accordance with its due importance. As a result, the feature-weighting and machine learning analysis from the Gini-Index as applied to the random classifier model serves as a robust predictor for what a user might access while taking into account associated variables which one may not normally correlate with having importance. Consequently, a strong level of prediction can be made, and a corresponding records or fields or predetermined number of records or fields (per their Gini Index) may be included in the top N fields displayed to the user (as shown in FIG. 3 and discussed above in reference to FIG. 3).

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, comprising:
causing, by at least one processor, a plurality of fields to be displayed based on a plurality of scores for the plurality of records;
receiving, by the at least one processor, a selection of a first field of the plurality of fields;
causing, by the at least one processor and in response to the selection of the first field, a plurality of records of a record type comprising the first field to be displayed;
receiving, by the at least one processor, a selection of a first record of the plurality of records;
generating, by the at least one processor and based on the selection of the first record, a first form comprising a first graphical user interface (GUI) component for the first field in the first record;
receiving, by the at least one processor and via the first GUI component, a first updated value for the first field in the first record; and
storing, by the at least one processor, the first updated value in the first field in the first record.

2. The method of claim 1, further comprising:
populating the first GUI component with an existing value of the first field in the first record before receiving the first updated value.

3. The method of claim 1, further comprising:
determining that a second field is frequently updated after the first field,
wherein the first form comprises a second GUI component for the second field in response to determining that the second field is frequently updated after the first field;
receiving, via the second GUI component, a second updated value for the second field in the first record; and
storing the second updated value in the second field in the first record.

4. The method of claim 1, wherein receiving the selection of the first record comprises receiving a selection of a subset of the plurality of records, the subset of the plurality of records comprising the first record and a second record.

5. The method of claim of claim 4, further comprising:
generating a second form comprising a second graphical user interface (GUI) component for the first field in the second record;
displaying the second form in response to a selection of a button on the first form;
receiving, via the second GUI component, a second updated value for the first field in the second record; and
storing the second updated value in the first field in the second record.

6. The method of claim 1, wherein the first field is associated with a score of the plurality of scores, wherein the score associated with the first field is incremented in response to an update to the first field, and wherein the score decays over time.

7. The method of claim 1, wherein the plurality of scores is determined using a random forest technique.

8. A system comprising:
a memory; and
at least one processor coupled to the memory and configured to:
cause a plurality of fields to be displayed based on a plurality of scores for the plurality of records;
receive a selection of a first field of the plurality of fields;
cause, in response to the selection of the first field, a plurality of records of a record type comprising the first field to be displayed;
receive a selection of a first record of the plurality of records;
generate, based on the selection of the first record, a first form comprising a first graphical user interface (GUI) component for the first field in the first record;
receive, via the first GUI component, a first updated value for the first field in the first record; and
store the first updated value in the first field in the first record.

9. The system of claim 8, wherein the at least one processor is further configured to:
populate the first GUI component with an existing value of the first field in the first record before receiving the first updated value.

10. The system of claim 8, wherein the at least one processor is further configured to:
determine that a second field is frequently updated after the first field,
wherein the first form comprises a second GUI component for the second field in response to determining that the second field is frequently updated after the first field;
receive, via the second GUI component, a second updated value for the second field in the first record; and
store the second updated value in the second field in the first record.

11. The system of claim 8, wherein receiving the selection of the first record comprises receiving a selection of a subset of the plurality of records, the subset of the plurality of records comprising the first record and a second record.

12. The system of claim 11, wherein the at least one processor is further configured to:
generate a second form comprising a second graphical user interface (GUI) component for the first field in the second record;
display the second form after the first form in response to a selection of a button on the first form;
receive, via the second GUI component, a second updated value for the first field in the second record; and
store the second updated value in the first field in the second record.

13. The system of claim 8, wherein the first field is associated with a score of the plurality of scores, wherein the score associated with the first field is incremented in response to an update to the first field, and wherein the score decays over time.

14. The system of claim 8, wherein the plurality of scores is determined using a random forest technique.

15. A non-transitory computer-readable medium (CRM) having instructions stored thereon that, when executed by at least one computing device, cause the at least one computing device to perform operations comprising:
causing a plurality of fields to be displayed based on a plurality of scores for the plurality of records;
receiving a selection of a first field of the plurality of fields;
causing, in response to the selection of the first field, a plurality of records of a record type comprising the first field to be displayed;
receiving a selection of a first record of the plurality of records;
generating, based on the selection of the first record, a first form comprising a first graphical user interface (GUI) component for the first field in the first record;
receiving, via the first GUI component, a first updated value for the first field in the first record; and
storing the first updated value in the first field in the first record.

16. The non-transitory CRM of claim 15, the operations further comprising:
populating the first GUI component with an existing value of the first field in the first record before receiving the first updated value.

17. The non-transitory CRM of claim 15, the operations further comprising:
determining that a second field is frequently updated after the first field,
wherein the first form comprises a second GUI component for the second field in response to determining that the second field is frequently updated after the first field;
receiving, via the second GUI component, a second updated value for the second field in the first record; and
storing the second updated value in the second field in the first record.

18. The non-transitory CRM of claim 15, wherein receiving the selection of the first record comprises receiving a selection of a subset of the plurality of records, the subset of the plurality of records comprising the first record and a second record.

19. The non-transitory CRM of claim 18, the operations further comprising:
generating a second form comprising a second graphical user interface (GUI) component for the first field in the second record;
displaying the second form in response to a selection of a button on the first form;
receiving, via the second GUI component, a second updated value for the first field in the second record; and
storing the second updated value in the first field in the second record.

20. The non-transitory CRM of claim 15, wherein the first field is associated with a score of the plurality of scores, wherein the score associated with the first field is incremented in response to an update to the first field, and wherein the score decays over time.
